(19) United States
(12) Patent Application Publication
(10) Pub. No.: US 2015/0116197 A1
(43) Pub. Date: Apr. 30, 2015

(54) SYSTEMS AND METHODS FOR DISPLAYING THREE-DIMENSIONAL IMAGES ON A VEHICLE INSTRUMENT CONSOLE

(71) Applicant: Johnson Controls Technology Company, Holland, MI (US)

(72) Inventor: Lawrence Robert Hamelink, Hamilton, MI (US)

(73) Assignee: Johnson Controls Technology Company, Holland, MI (US)

(21) Appl. No.: 14/062,086

(22) Filed: Oct. 24, 2013

(51) Int. Cl. H04N 13/04; G06F 3/01

(52) U.S. Cl. CPC H04N 13/0484; G06F 3/013
USPC 345/156

(57) ABSTRACT

A system includes a gaze tracker configured to provide gaze data corresponding to a direction that an operator is looking. One or more processors are configured to analyze the gaze data to determine whether a display is in a central vision of the operator or whether the display is in a peripheral vision of the operator. The processors are further configured to provide a first type of image data to the display if the display is in the central vision and a second type of image data to the display if the display is in the peripheral vision. The first type of image data includes first three-dimensional (3D) image data that produces a first 3D image when the display is within the central vision. The second type of image data includes second 3D image data that produces a second 3D image when the display is within the peripheral vision.

### BACKGROUND

The invention relates generally to motor vehicles, and more particularly, to systems and methods for displaying three-dimensional images on a vehicle instrument console.

Vehicles often include a variety of displays to provide a driver with information. For example, certain vehicles include a display in the vehicle instrument console which provides the driver with information relating to a speed of the vehicle, a number of revolutions per minute, a gas quantity, an engine temperature, a seat belt status, and so forth. Furthermore, certain vehicles include a display in the vehicle instrument console that provides the driver with information relating to a time, a radio station, directions, air conditioning, and so forth. Moreover, displays may be used to show three-dimensional (3D) images. As may be appreciated, the 3D images on the displays may be discernable only when the driver is looking directly at the display. As a result, displaying 3D images for the driver when the driver is not looking directly at the display may provide little information to the driver. For instance, while the driver is gazing down the road, focusing on distant objects ahead, the 3D images may be indiscernible because they are in the driver's peripheral vision. In certain configurations, 3D images in the driver's peripheral vision may appear blurred and/or doubled. Further, the 3D images may be too small in the driver's peripheral vision to accurately discern.

### BRIEF DESCRIPTION OF THE INVENTION

The present invention relates to a system including a gaze tracker configured to provide gaze data corresponding to a direction that an operator is looking. The system also includes one or more processors configured to analyze the gaze data to determine whether a display is in a central vision of the operator or whether the display is in a peripheral vision of the operator. The processors are further configured to provide a first type of image data to the display if the display is in the central vision of the operator and a second type of image data to the display if the display is in the peripheral vision of the operator. The first type of image data includes first three-dimensional (3D) image data that produces a first 3D image when the display is within the central vision of the operator. The second type of image data includes second 3D image data that produces a second 3D image when the display is within the peripheral vision of the operator.

The present invention also relates to a non-transitory machine readable computer media including computer instructions configured to receive gaze data and analyze the gaze data to determine whether a display is in a central vision of an operator or whether the display is in a peripheral vision of the operator. The computer instructions are further configured to provide a first type of image data to the display if the display is in the central vision of the operator, and to provide a second type of image data to the display if the display is in the peripheral vision of the operator. The first type of image data includes 3D image data that produces a first 3D image when the display is within the central vision of the operator. The second type of image data includes second 3D image data that produces a second 3D image when the display is within the peripheral vision of the operator.

The present invention further relates to a method that includes receiving gaze data by one or more processors and analyzing the gaze data to determine whether a display is in a central vision of an operator or whether the display is in a peripheral vision of the operator. The method also includes providing, using the one or more processors, a first type of image data to the display if the display is in the central vision of the operator, and providing a second type of image data to the display if the display is in the peripheral vision of the operator. The first type of image data includes first 3D image data that produces a first 3D image when the display is within the central vision of the operator. The second type of image data includes second 3D image data that produces a second 3D image when the display is within the peripheral vision of the operator.

### DRAWINGS

FIG. 1 is a perspective view of an embodiment of a vehicle including a gaze tracker and a display for displaying different three-dimensional (3D) images based upon where an operator is looking.

FIG. 2 is a block diagram of an embodiment of a system for modifying a 3D image provided to a display based upon where an operator is looking in order to compensate for peripheral parallax.

FIG. 3 is a side view of an embodiment of a central vision and a peripheral vision of an operator.

FIG. 4 is a perspective view of an embodiment of an operator gazing directly at a display and a first 3D image being displayed on the display.

FIG. 5 is a perspective view of an embodiment of an operator gazing away from a display and a second 3D image being displayed on the display.

FIG. 6 is a diagram of an embodiment of a system for compensating for peripheral parallax.

FIG. 7 is a flow chart of an embodiment of a method for displaying a first 3D image or a second 3D image based upon whether a display is in a central vision or a peripheral vision of an operator.

### DETAILED DESCRIPTION

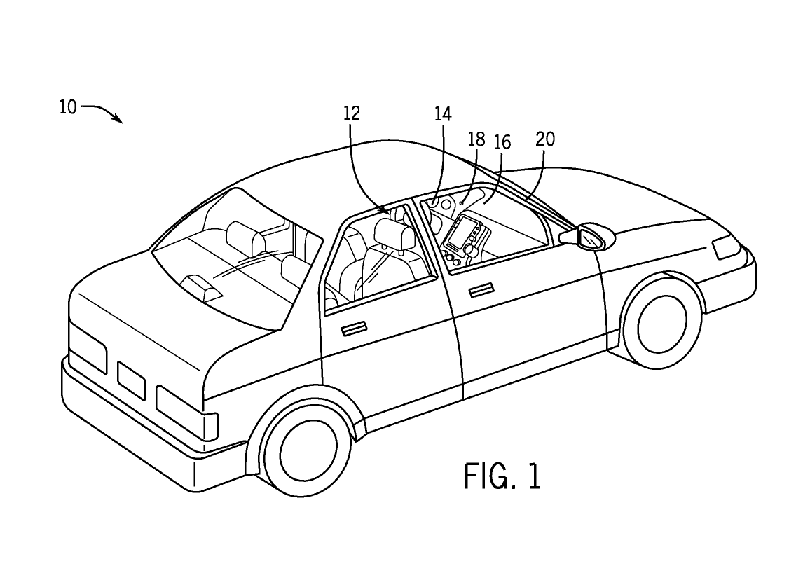

FIG. 1 is a perspective view of an embodiment of a vehicle 10 including a gaze tracker and a display for displaying different three-dimensional (3D) images based upon where an operator is looking. As illustrated, the vehicle 10 includes an interior 12 having a display 14 on an instrument console 16. The display 14 may include an electronic interface capable of displaying 3D images, such as by using autostereoscopy. As such, the display 14 may display 3D images and may not require 3D glasses in order to perceive the 3D images. As illustrated, the display 14 is mounted in the instrument console 16 in a location in which a speedometer and/or a revolutions per minute gauge are typically located. In other embodiments, the display 14 may be coupled to a heads-up display, another portion of the instrument console 16, and/or the display 14 may be projected onto a windshield of the vehicle 10.

The vehicle 10 includes a gaze tracker 18. In the illustrated embodiment, the gaze tracker 18 is mounted to the instrument console 16. However, in other embodiments, the gaze tracker 18 may be mounted to the display 14, a steering column, a frame 20, a visor, a rear-view mirror, a door, or the like. As described in detail below, the gaze tracker 18 is configured to monitor a direction in which an operator is looking and to provide gaze data to a processing device. The processing device is configured to determine a direction of the operator's gaze and to provide a first or second type of image data to the display 14 based on the direction of the operator's gaze. The first type of image data includes first 3D image data that produces a first 3D image to be displayed and the second type of image data includes second 3D image data that produces a second 3D image to be displayed. The first and second 3D images are based on whether the display is in the operator's central or peripheral vision. Having separate 3D images based on where the operator is looking is beneficial because it may allow the operator to discern information on a display in the operator's peripheral vision that may otherwise be indiscernible. This may be accomplished by the 3D image displayed when the display in the peripheral vision of the operator removing peripheral parallax and being larger and more simplified than the 3D image displayed when the display is in the central vision of the operator.

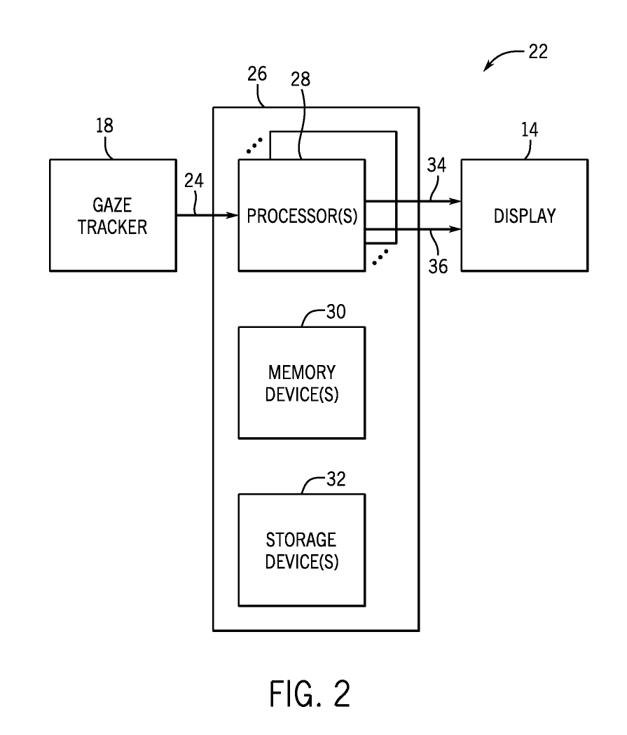

FIG. 2 is a block diagram of an embodiment of a system 22 for modifying a 3D image provided to the display 14 based upon where an operator is looking in order to compensate for peripheral parallax. As illustrated, the system 22 includes the gaze tracker 18, a processing device 26, and the display 14, among other things. The gaze tracker 18 may be configured to provide gaze data 24 corresponding to a direction that the operator is looking. As may be appreciated, the gaze data 24 may include directional information that includes an angle of gaze for each of the operator's eyes relative to the gaze tracker 18. Accordingly, in certain embodiments, the gaze tracker 18 may be configured to analyze gaze data 24 with respect to a location of the gaze tracker 18 relative to the operator.

The processing device 26 includes one or more processors 28, memory devices 30, and storage devices 32. The processor(s) 28 may be used to execute software, such as gaze data analysis software, image data compilation software, and so forth. Moreover, the processor(s) 28 may include one or more microprocessors, such as one or more “general-purpose” microprocessors, one or more special-purpose microprocessors and/or application specific integrated circuits (ASICS), or some combination thereof. For example, the processor(s) 28 may include one or more reduced instruction set (RISC) processors.

The memory device(s) 30 may include a volatile memory, such as random access memory (RAM), and/or a nonvolatile memory, such as read-only memory (ROM). The memory device(s) 30 may store a variety of information and may be used for various purposes. For example, the memory device(s) 30 may store processor-executable instructions (e.g., firmware or software) for the processor(s) 28 to execute, such as instructions for gaze data analysis software, image data compilation software, and so forth.

The storage device(s) 32 (e.g., nonvolatile storage) may include ROM, flash memory, a hard drive, or any other suitable optical, magnetic, or solid-state storage medium, or a combination thereof. The storage device(s) 32 may store data (e.g., gaze data 24, image data, etc.), instructions (e.g., software or firmware for gaze data analysis, image compilation, etc.), and any other suitable data.

In certain embodiments, the processing device 26 is configured to use the gaze data 24 to determine whether the display 14 is within a central vision or a peripheral vision of the operator. For example, the processing device 26 may be configured to store one or more angles of gaze in which the eyes could look for the display 14 to be within the central vision of the operator. Moreover, the processing device 26 may be configured to compare the gaze data 24 to the one or more stored angles of gaze. If the gaze data 24 indicates that the display 14 is within the central vision of the operator, then the processing device 26 may produce a first type of image data 34 to provide to the display 14. Conversely, if the gaze data 24 indicates that the display 14 is not within the central vision of the operator, then the processing device 26 may determine that the display is within the peripheral vision of the operator and may produce a second type of image data 36 to provide to the display 14.

The gaze data 24 may be streamed or otherwise provided from the gaze tracker to the processing device 26 in a variety of standard and/or non-standard data formats (e.g., binary data, text data, XML data, etc.), and the data may include varying levels of detail. As discussed above, the processing device 26 analyzes the gaze data 24 to determine whether the display 14 is in the central vision of the operator or whether the display 14 is in the peripheral vision of the operator and the processing device 26 provides image data to the display 14 accordingly.

If the display 14 is in the central vision of the operator, the processing device 26 sends the first type of image data 34 to the display 14. The first type of image data 34 may include first 3D image data. The display 14 may use the first 3D image data to produce a first 3D image. If the display 14 is in the peripheral vision of the operator, the processing device 26 sends the second type of image data 36 to the display 14. The second type of image data 36 includes second 3D image data. The display 14 may use the second 3D image data to produce a second 3D image. Although there may be many differences between the two types of image data sent (e.g., the first and second types of image data 34 and 36) to the display 14, in certain embodiments, the second type of image data 36 may contain instructions for the display 14 to display the second 3D image with graphics that compensate for peripheral parallax. As discussed in detail below, compensation may be accomplished by displaying images in the second 3D image that are offset from one another such that a first image viewed by a left eye of an operator and a second image viewed by a right eye of the operator converge to produce a single image in the peripheral vision of the operator.

The processing device 26 may include software such as computer instructions stored on non-transitory machine readable computer media (e.g., the memory device(s) 30 and/or the storage device(s) 32). The computer instructions may be configured to receive the gaze data 24 from the gaze tracker 18 (or from any other source), to analyze the gaze data 24 to determine whether the display 14 is in the central vision of the operator or whether the display 14 is in the peripheral vision of the operator, to provide a first type of image data 34 to the display 14 if the display 14 is in the central vision of the operator, and to provide a second type of image data 36 to the display 14 if the display 14 is in the peripheral vision of the operator. The first type of image data 34 provided by the computer instructions includes first 3D image data that produces a first 3D image when the display 14 is within the central vision of the operator, and the second type of image data 36 provided by the computer instructions includes second 3D image data that produces a second 3D image when the display 14 is within the peripheral vision of the operator. While only one processing device 26 is described in the illustrated embodiment, other embodiments may use more than one processing devices to receive gaze data, to analyze the gaze data to determine whether a display is in the central vision or peripheral vision of an operator, and to provide image data that includes different 3D images to a display.

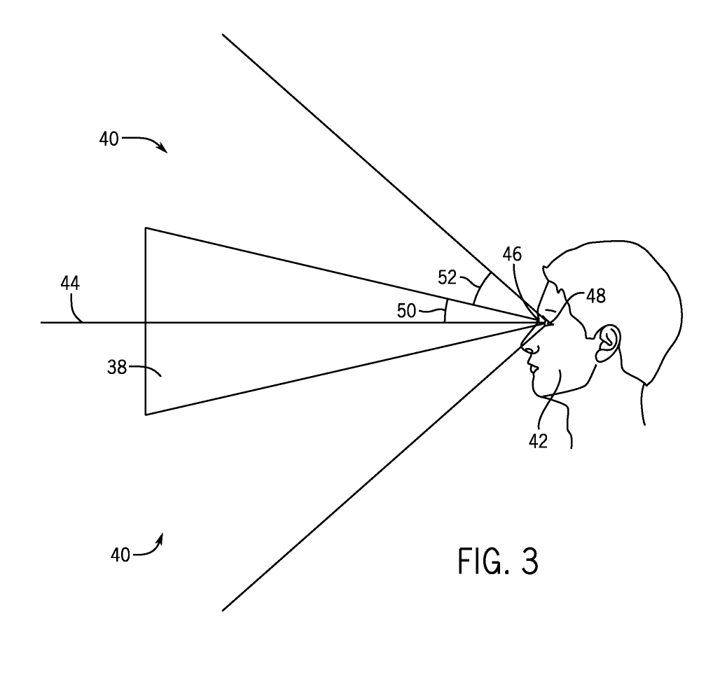

FIG. 3 is a side view of an embodiment of a central vision 38 and a peripheral vision 40 of an operator 42. As may be appreciated, the central vision 38 of one operator 42 may be considered the peripheral vision of another operator. Generally, the central vision 38 of the operator 42 may be broadly defined as where the operator 42 is directly looking or focusing. In other words, the central vision 38 may include what is in the operator's 42 direct line of sight 44. Furthermore, the central vision 38 of the operator 42 may also be referred to as the operator's 42 gaze. For example, an object that the operator 42 is gazing at (e.g., the display 14 or a road) is also in the operator's 42 direct line of sight 44 and, thus, in the operator's 42 central vision 38. As may be appreciated, the central vision 38 may include a range of vision that is not the peripheral vision 40.

Accordingly, anything that is outside of an operator's 42 gaze, or central vision 38, may be considered as being in the operator's 42 peripheral vision 40. When the operator 42 gazes at an object, images received by the operator's 42 right eye 46 and by the operator's 42 left eye 48 converge to produce a single perceived image of the object in the operator's 42 mind. Thus, the operator's 42 right eye 46 and left eye 48 are not focused on objects in the peripheral vision because each eye is gazing at the object in the central vision 38 of the operator 42. Moreover, the right eye 46 and left eye 48 each see peripheral objects at different angles, which may result in peripheral objects appearing blurred and/or double (e.g., peripheral parallax). As discussed in detail below, changing a layout and/or size of 3D images on the display 14 may compensate for such peripheral parallax.

In the illustrated embodiment, the central vision 38 includes a central vision angle 50 on each side of the operator's 42 direct line of sight 44. Furthermore, the peripheral vision 40 includes a peripheral vision angle 52 on each side of the operator's 42 central vision 38. However, it should be noted that each operator's 42 vision may vary and, thus, the central vision angle 50 and the peripheral vision angle 52 vary. In one exemplary operator 42, the operator 42 may have approximately a one hundred eighty degree forward facing field of vision. The one hundred eighty degrees may be split in half by the operator's 42 direct line of sight 44. Thus, there may be ninety degrees that surround the direct line of sight 44. For example, in some operators 42, the central vision angle 50 may make up roughly ten to twenty degrees of the ninety degrees surrounding the direct line of sight 44 and anything visible within that range may be considered in the central vision 38 of the operator 42. The remaining seventy to eighty degrees may be considered the peripheral vision angle 52 and anything visible within that range may be considered in the peripheral vision 40 of the operator 42. As may be appreciated, the ranges provided herein are illustrative to demonstrate how angle ranges may be used in certain embodiments to determine when objects are within the central vision 38 or the peripheral vision 40 of operators.

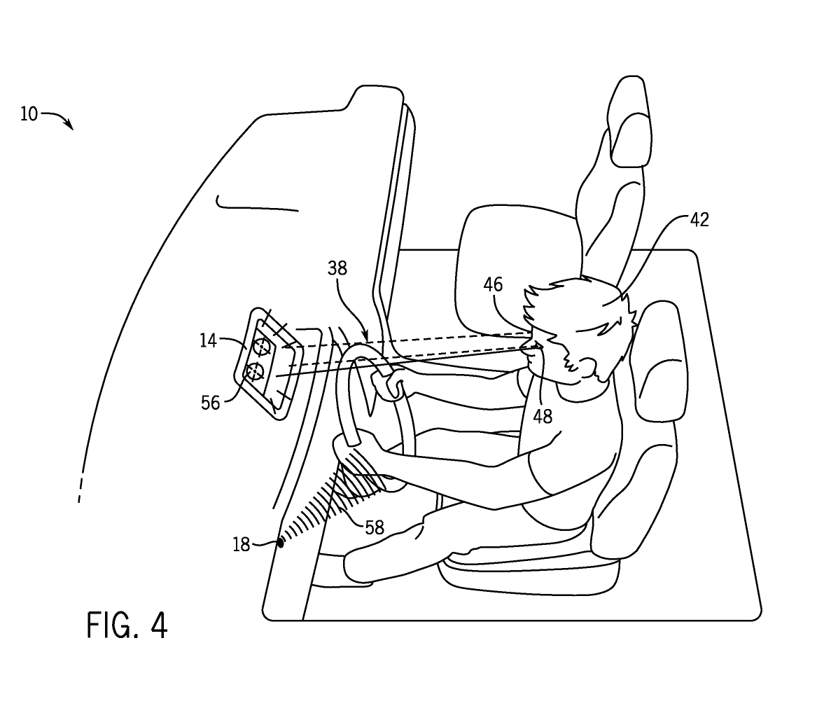

FIG. 4 is a perspective view of an embodiment of the operator 42 gazing directly at the display 14 and a first 3D image 56 being displayed on the display 14. In the illustrated embodiment, the operator's 42 right eye 46 and left eye 48 are both viewing the display 14 in the vehicle 10. As illustrated, the gaze tracker 18 emits signals 58 (e.g., infrared signals, etc.) that reflect off of the operator's 42 right eye 46 and left eye 48. The gaze tracker 18 uses the reflection to detect which direction each eye is looking. The gaze tracker 18 stores data corresponding to which direction each eye is looking as gaze data. In certain embodiments, the gaze data may include data corresponding to a spatial position of each eye and/or a direction of gaze of each eye relative to the gaze tracker 18, among other information. The gaze tracker 18 provides the gaze data to a processing device (e.g., the processing device 26) that determines whether the display 14 is in the central vision 38 of the operator 42 or whether the display 14 is in the peripheral vision 40 of the operator 42.

In the illustrated embodiment, the display 14 is in the central vision 38 of the operator 42 so the processing device provides first 3D image data to the display 14 which displays the first 3D image 56. The first 3D image 56 does not require 3D glasses to be seen on the display 14 because of the 3D autostereoscopic nature of the first 3D image data. As may be appreciated, the first 3D image 56 may include graphics for a speed, a gas level, a seat belt indicator, an airbag indicator, a revolutions per minute, and so forth. In certain embodiments, the first 3D image 56 contains a greater number of graphics than a second 3D image. Also, the first 3D image 56 may contain graphics that are smaller in size than graphics of the second 3D image. In other embodiments, the first 3D image 56 and the second 3D image may include the same number of graphics and/or the same size graphics.

In certain embodiments, a graphic may mean a graphical item displayed on the display 14 or stored as data. For example, a graphic may include a numerical value indicating the speed at which the car is traveling, a number indicating the revolutions per minute, or an image such as a seat belt indicator, a gas level indicator, and so forth. Furthermore, according to certain embodiments, the graphics may be any size, shape, or color.

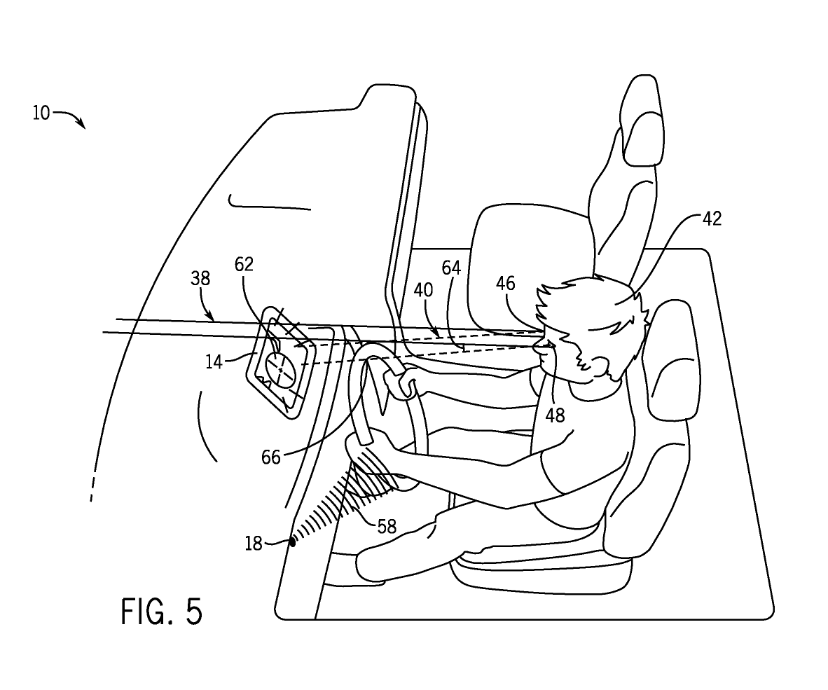

FIG. 5 is a perspective view of an embodiment of the operator 42 gazing away from the display 14 and a second 3D image 62 being displayed on the display 14. In the illustrated embodiment, an operator's 42 right eye 46 and left eye 48 are not looking at the display 14, but are focused on looking through a windshield of the vehicle 10. In the illustrated embodiment, the display 14 is not in the central vision 38 of the operator 42. Instead, the operator's 42 central vision 38 is focused on looking through the windshield. Accordingly, an angle 64 between the central vision 38 and a direct line 66 between the operator's 42 eyes 46 and 48 places the display 14 outside of the central vision 38 of the operator 42. Thus, the processing device may determine that the display 14 is within the peripheral vision 40 of the operator 42 and may provide second 3D image data to the display 14. Thus, the display 14 shows the second 3D image 62. Again, the second 3D image 62 also does not require 3D glasses to be seen on the display 14 because of the 3D autostereoscopic nature of the second 3D image data. As may be appreciated, the second 3D image 62 may include graphics for a speed, a gas level, a seat belt indicator, an airbag indicator, a revolution per minute, and so forth. In certain embodiments, the second 3D image 62 includes fewer graphics than the first 3D image 56. Furthermore, the second 3D image 62 may contain graphics that are larger in size than graphics of the first 3D image 56. In other embodiments, the second 3D image 62 and the first 3D image 56 may include the same number of graphics and/or the same size graphics. The second 3D image may differ from the first 3D image to account for the display being in the operator's peripheral vision. For example, the second 3D image may remove peripheral parallax and display larger and more simplified images, which may enable the operator to discern the information present in the second 3D image that would otherwise be indiscernible when the display is in the operator's peripheral vision.

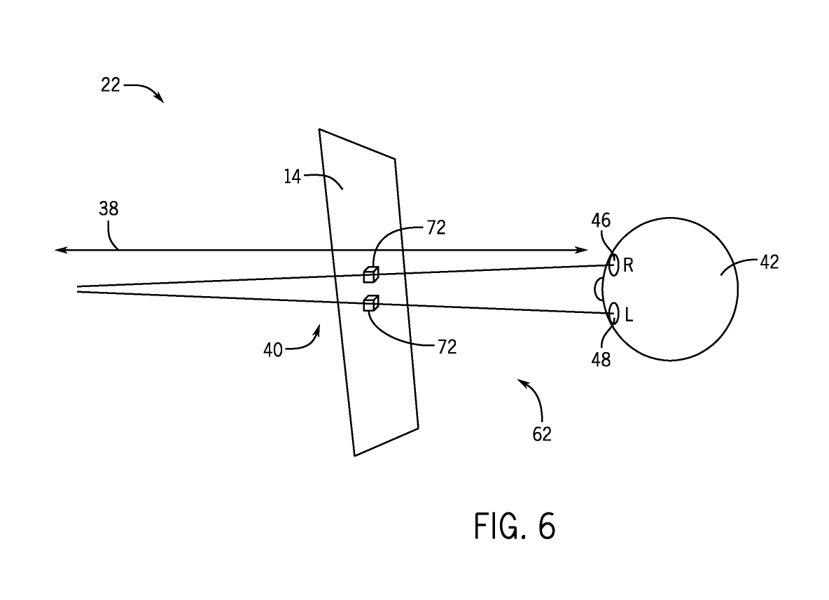

FIG. 6 is a diagram of an embodiment of the system 22 for compensating for peripheral parallax. In the illustrated embodiment, the central vision 38 of the operator 42 is not directed toward the display 14. Thus, unaltered graphics of a 3D image on the display 14 may be indiscernible by the operator 42 because of peripheral parallax. In order to compensate for the peripheral parallax, a pair of offset graphics or images 72 are positioned on the display 14, a first image is configured to be received by the operator's 42 right eye 46 and a second image is configured to be received by the operator's 42 left eye 48. Thus, the second 3D image 62 is produced by the offset graphics or images 72 that converge to produce a single image in the peripheral vision 40 of the operator 42.

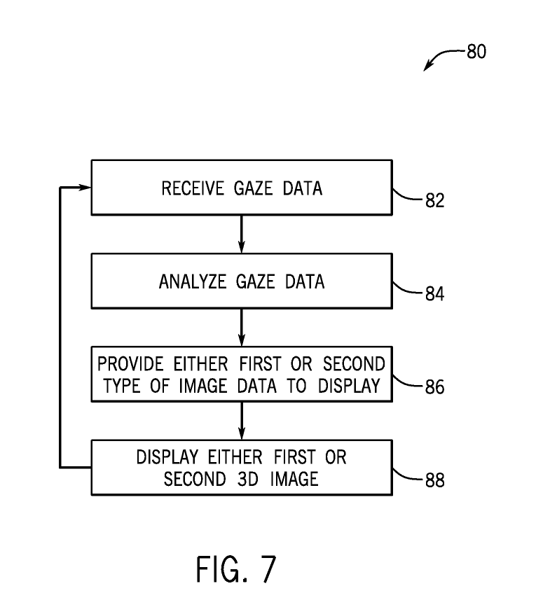

FIG. 7 is a flow chart of an embodiment of a method for displaying a first 3D image or a second 3D image based upon whether a display is in the central vision 38 or the peripheral vision 40 of the operator 42. The method includes one or more processors receiving gaze data (block 82). The gaze data may be sent by the gaze tracker 18 or by any other source, such as by an intermediary component (e.g. middleware application). The gaze data corresponds to a direction an operator is looking. Next, the method 80 includes analyzing the gaze data to determine whether the display 14 is in the central vision 38 of the operator 42 or whether the display 14 is in the peripheral vision 40 of the operator 42 (block 84). Then, the method 80 includes providing either a first or second type of image data to the display 14 (block 86). The first type of image data may be provided to the display 14 if the display 14 is in the central vision 38 of the operator 42. The second type of image data may be provided to the display 14 if the display 14 is in the peripheral vision 40 of the operator 42. Further, the first type of image data includes first 3D image data that produces a first 3D image and the second type of image data includes second 3D image data that produces a second 3D image. The first and/or the second 3D image is displayed by the display 14 (block 88). The method 80 then returns to block 82 to repeat blocks 82 through 88. This method provides the benefit of allowing the operator to discern pertinent information in the second 3D image when the display is in the operator's peripheral vision that may otherwise be indiscernible.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A system comprising:
a gaze tracker configured to provide gaze data corresponding to a direction that an operator is looking; and
one or more processors configured to analyze the gaze data to determine whether a display is in a central vision of the operator or whether the display is in a peripheral vision of the operator, to provide a first type of image data to the display if the display is in the central vision of the operator, and to provide a second type of image data to the display if the display is in the peripheral vision of the operator, wherein the first type of image data comprises first three-dimensional (3D) image data that produces a first 3D image when the display is within the central vision of the operator, and the second type of image data comprises second 3D image data that produces a second 3D image when the display is within the peripheral vision of the operator.

2. The system of claim 1, comprising the display.

3. The system of claim 2, wherein the display is mounted in an instrument console.

4. The system of claim 2, wherein the display is part of a heads-up display.

5. The system of claim 1, wherein the first and second 3D images are viewable without 3D glasses.

6. The system of claim 1, wherein a first graphic of the first 3D image is a smaller representation of a second graphic of the second 3D image.

7. The system of claim 1, wherein the second 3D image comprises a subset of graphics from the first 3D image.

8. The system of claim 1, wherein the second 3D image is produced by displaying a first image and a second image on the display, wherein the first and second images are offset from one another, the first image is configured to be viewed by a left eye of the operator, the second image is configured to be viewed by a right eye of the operator, and the first and second images converge to produce a single image in the peripheral vision of the operator.

9. The system of claim 1, wherein the second 3D image comprises at least one of a speed, a gas level, a seat belt indicator, an airbag indicator, an engine coolant temperature indicator, a revolution per minute, or any combination thereof.

10. The system of claim 1, wherein analyzing the gaze data comprises analyzing the gaze data with respect to a location of the gaze tracker relative to the operator.

11. The system of claim 1, wherein the gaze tracker is mounted to the display, a steering column, an instrument console, a frame, a visor, a rear-view mirror, a door, or some combination thereof.

12. A non-transitory machine readable computer media comprising computer instructions configured to:
receive gaze data;
analyze the gaze data to determine whether a display is in a central vision of an operator or whether the display is in a peripheral vision of the operator; and
provide a first type of image data to the display if the display is in the central vision of the operator, and provide a second type of image data to the display if the display is in the peripheral vision of the operator, wherein the first type of image data comprises first three-dimensional (3D) image data that produces a first 3D image when the display is within the central vision of the operator, and the second type of image data comprises second 3D image data that produces a second 3D image when the display is within the peripheral vision of the operator.

13. The non-transitory machine readable computer media of claim 12, wherein the gaze data corresponds to a direction than the operator is looking.

14. The non-transitory machine readable computer media of claim 13, wherein the computer instructions are configured to analyze the gaze data with respect to a location of a gaze tracker relative to the operator.

15. The non-transitory machine readable computer media of claim 12, wherein a first graphic of the first 3D image is a smaller representation of a second graphic of the second 3D image.

16. The non-transitory machine readable computer media of claim 12, wherein the second 3D image comprises a subset of graphics from the first 3D image.

17. The non-transitory machine readable computer media of claim 12, wherein the second 3D image is produced by displaying a first image and a second image on the display, wherein the first and second images are offset from one another, the first image is configured to be viewed by a left eye of the operator, the second image is configured to be viewed by a right eye of the operator, and the first and second images converge to produce a single image in the peripheral vision of the operator.

18. The non-transitory machine readable computer media of claim 12, wherein the first and second 3D images are viewable without 3D glasses.

19. A method comprising:
receiving gaze data by one or more processors;
analyzing the gaze data using the one or more processors to determine whether a display is in a central vision of an operator or whether the display is in a peripheral vision of the operator; and
providing, using the one or more processors, a first type of image data to the display if the display is in the central vision of the operator, and providing a second type of image data to the display if the display is in the peripheral vision of the operator, wherein the first type of image data comprises first three-dimensional (3D) image data that produces a first 3D image when the display is within the central vision of the operator, and the second type of image data comprises second 3D image data that produces a second 3D image when the display is within the peripheral vision of the operator.

20. The method of claim 19, wherein a first graphic of the first 3D image is a smaller representation of a second graphic of the second 3D image.
